(19) United States
(12) Patent Application Publication
(10) Pub. No.: US 2019/0272568 A1
(43) Pub. Date: Sep. 5, 2019

(54) RECOMMENDATION DEVICE, INFORMATION TERMINAL, RECOMMENDATION METHOD, AND NON-TRANSITORY STORAGE MEDIUM

(71) Applicant: TOYOTA JIDOSHA KABUSHIKI KAISHA, Toyota-shi (JP)

(72) Inventors: Kazuhiro UMEDA, Nisshin-shi (JP); Takumi Fukunaga, Nisshin-shi (JP); Makoto Akahane, Nagoya-shi (JP); Satoshi Usui, Machida-shi (JP)

(73) Assignee: TOYOTA JIDOSHA KABUSHIKI KAISHA, Toyota-shi (JP)

(21) Appl. No.: 16/289,970

(22) Filed: Mar. 1, 2019

(30) Foreign Application Priority Data
Mar. 1, 2018 (JP) 2018036604

(51) Int. Cl. G06Q 30/02; G06Q 30/06; G01C 21/34; G06F 16/29

(52) U.S. Cl. CPC G06Q 30/0282; G06F 16/29; G01C 21/3407; G06Q 30/0645

(57) ABSTRACT

A recommendation device includes: a search instruction receiving unit configured to receive a search instruction including a purpose and a movement start position, the purpose and the movement start position being input by a user; a route searching unit configured to, based on the search instruction, search for a route for movement from the movement start position to a place corresponding to the purpose; and a recommendation unit configured to generate, based on the route, recommendation information including at least a rental place of a vehicle, the vehicle being used for a service of car sharing, and a return place of the vehicle, and present the recommendation information to the user.

### INCORPORATION BY REFERENCE

The disclosure of Japanese Patent Application No. 2018-036604 filed on Mar. 1, 2018 including the specification, drawings and abstract is incorporated herein by reference in its entirety.

### BACKGROUND

### 1. Technical Field

The disclosure relates to a recommendation device, an information terminal, a recommendation method, and a non-transitory storage medium.

### 2. Description of Related Art

Japanese Unexamined Patent Application Publication No. 2016-206715 (JP 2016-206715 A) discloses a technique of preparing recommendation information based on the utilization records of a user, the attributes of a user, and the like and providing recommendation information to a user who has applied for a reservation for a car sharing service.

### SUMMARY

In JP 2016-206715 A, recommendation information is provided to a user who uses a car sharing service, but recommendation information is not provided to a user who does not use a car sharing service. Accordingly, it is not satisfactory from the viewpoint of promotion of use of a car sharing service.

The disclosure provides a recommendation device, an information terminal, a recommendation method, and a non-transitory storage medium that can promote use of a car sharing service.

A first aspect of the disclosure provides a recommendation device. The recommendation device includes: a search instruction receiving unit configured to receive a search instruction including a purpose and a movement start position, the purpose and the movement start position being input by a user; a route searching unit configured to, based on the search instruction, search for a route for movement from the movement start position to a place corresponding to the purpose; and a recommendation unit configured to generate, based on the route, recommendation information including at least a rental place of a vehicle, the vehicle being used for a service of car sharing, and a return place of the vehicle, and present the recommendation information to the user.

In the first aspect, the recommendation device may include a reservation receiving unit configured to, from the user, receive application for a reservation for use of the vehicle at the rental place and the return place; and a reservation settling unit configured to settle the reservation for use of the vehicle, the vehicle being a target of the application.

In the first aspect, the recommendation device may include: a place selecting unit configured to search for a place using the purpose; and a selection receiving unit configured to present, to the user, a plurality of places searched out by the place searching unit, and receive, from the user, selection of a target place corresponding to the purpose, wherein the route searching unit may be configured to search for a route for movement from the movement start position to the target place.

In the first aspect, the recommendation information may include, as a transportation system used for movement, at least one of a railway, a bus, an aircraft, and a ship in addition to the vehicle.

A second aspect of the disclosure provides an information terminal. The information terminal includes: a transmission unit configured to transmit a search instruction including a purpose and a movement start position in response to an operation instruction from a user; and a display unit configured to receive and display recommendation information including a route for movement from the movement start position to a place corresponding to the purpose, the recommendation information including at least a rental place of a vehicle used for a service of car sharing and a return place of the vehicle.

A third aspect of the disclosure provides recommendation method performed by a processor. The recommendation method includes: receiving a search instruction including a purpose and a movement start position, the purpose and the movement start position being input by a user; searching, based on the search instruction, for a route for movement from the movement start position to a place corresponding to the purpose; generating, based on the route, recommendation information including at least a rental place of a vehicle used for a service of car sharing and a return place of the vehicle; and presenting the recommendation information to the user.

A fourth aspect of the disclosure provides a recommendation method performed by a processor. The recommendation method includes: transmitting a search instruction including a purpose and a movement start position in response to an operation instruction from a user; and receiving and displaying recommendation information including a route for movement from the movement start position to a place corresponding to the purpose, the recommendation information including at least a rental place of a vehicle used for a service of car sharing and a return place of the vehicle.

A fifth aspect of the disclosure provides a non-transitory storage medium storing a recommendation program. The recommendation program causes a computer to perform: receiving a search instruction including a purpose and a movement start position, the purpose and the movement start position being input by a user; searching, based on the search instruction, for a route for movement from the movement start position to a place corresponding to the purpose; generating, based on the route, recommendation information; and presenting the recommendation information to the user, the recommendation information including at least a rental place of a vehicle used for a service of car sharing and a return place of the vehicle.

A sixth aspect of the disclosure provides non-transitory storage medium storing a recommendation program. The recommendation program causes a computer to perform: transmitting a search instruction including a purpose and a movement start position in response to an operation instruction from a user; and receiving and displaying recommendation information including a route for movement from the movement start position to a place corresponding to the purpose, the recommendation information including at least a rental place of a vehicle which is used for a service of car sharing and a return place of the vehicle.

According to the aspects, it is possible to provide a recommendation device, an information terminal, a recommendation method, and a non-transitory storage medium that can promote use of a car sharing service.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a configuration of a recommendation system including a server according to an embodiment; and

FIG. 2 is a flowchart illustrating an example of an operation which is performed by the server according to the embodiment.

### DETAILED DESCRIPTION OF EMBODIMENTS

Hereinafter, an exemplary embodiment of the disclosure will be described with reference to the accompanying drawings. In the drawings, elements referred to by the same reference signs have the same or similar configuration.

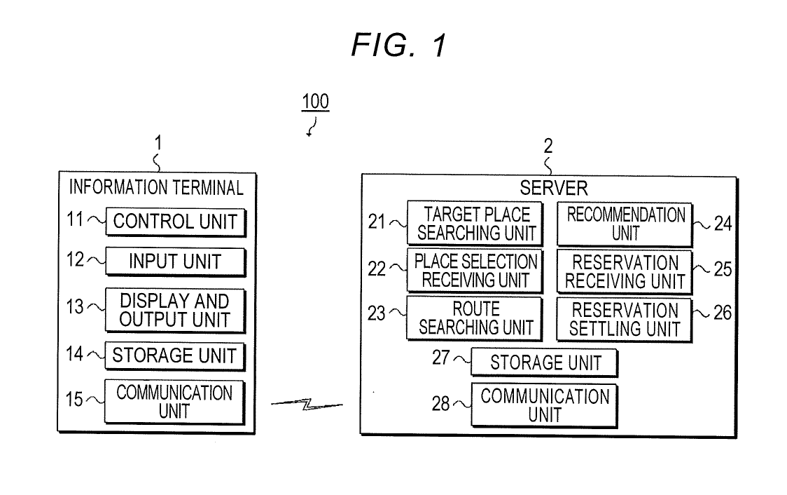

A configuration of a recommendation system including a server (a recommendation device) according to an embodiment will be described below with reference to FIG. 1. The recommendation system 100 includes, for example, an information terminal 1 that is carried by a user and a server 2 that manages information on a vehicle to be shared (hereinafter also referred to as a “sharing vehicle”) and presents recommendation information to a user. The information terminal 1 and the server 2 are configured to communicate with each other, for example, via a network including a radio network.

The information terminal 1 illustrated in FIG. 1 is a terminal device such as a smartphone. Here, the information terminal 1 is not limited to a smartphone and, for example, a tablet terminal, a mobile phone, a mobile information terminal, a notebook personal computer (PC), a PC, and other terminals can be appropriately used. The information terminal 1 includes, for example, a control unit 11, an input unit 12, a display and output unit 13, a storage unit 14, and a communication unit 15 as functional elements. The information terminal 1 includes, for example, a control unit including a central processing unit (CPU) and a memory, an operation unit, a display, a speaker, a storage unit, and a communication unit as physical elements. By causing the CPU to execute a predetermined program stored in the memory, the functions of the control unit 11, the input unit 12, the display and output unit 13, the storage unit 14, and the communication unit 15 are implemented.

The server 2 includes, for example, a target place searching unit 21, a place selection receiving unit 22, a route searching unit 23, a recommendation unit 24, a reservation receiving unit 25, a reservation settling unit 26, a storage unit 27, a communication unit (a search instruction receiving unit) 28 as functional elements. The server 2 includes, for example, a control unit including a CPU and a memory, a storage unit, and a communication unit as physical elements. By causing the CPU to execute a predetermined program stored in the memory, the functions of the target place searching unit 21, the place selection receiving unit 22, the route searching unit 23, the recommendation unit 24, the reservation receiving unit 25, the reservation settling unit 26, the storage unit 27, and the communication unit 28 are implemented.

The server 2 stores and manages vehicle information corresponding to each sharing vehicle in a database or the like. The vehicle information includes, for example, a vehicle ID for identifying the corresponding sharing vehicle and use reservation information of the sharing vehicle.

The use reservation information of a sharing vehicle includes, for example, a user ID for identifying a user who has reserved use thereof, a scheduled use start time, a scheduled use start place, a scheduled return time, and a scheduled return place.

The communication unit 28 receives a search instruction which is transmitted from the information terminal 1. The search instruction includes, for example, a purpose and a movement start position which are arbitrarily input by a user. The purpose is expressed as, for example, a genre of a place to which a user wants to go such as tourism, a meal, shopping, a hot spring, or an amusement facility.

The movement start position is a place at which a user starts movement. A current position of the user may be designated as the movement start position. In this case, the current position may be arbitrarily set as a default of the movement start position.

In addition to the purpose and the movement start position, any conditions when going out can be appropriately included in the search instruction. Examples of the conditions include conditions associated with a companion such as a child or an elderly person, conditions associated with a period of time such as a day trip or an overnight trip, conditions associated with a moving distance such as a close place or a distant place, and conditions associated with an estimated cost as cheap as possible or luxury.

The target place searching unit 21 searches for one or more places using the purpose included in the search instruction as a search key. When the conditions at the time of going out are included in the search instruction, the target place searching unit 21 searches for a place using the purpose and the conditions as a search key.

When the target place searching unit 21 has searched out a plurality of places, the place selection receiving unit 22 presents the plurality of places to a user and receives selection of one or more places matching the user's purpose from the user. Accordingly, places to be searched out can be narrowed down to places which are desired by the user.

The route searching unit 23 searches for one or more routes for movement from the movement start position to the place selected by the user based on the search instruction.

The recommendation unit 24 generates recommendation information based on the one or more routes searched out by the route searching unit 23 and presents the generated recommendation information to the user. An example of a procedure thereof will be described below.

First, the recommendation unit 24 identifies all transportation systems which can be used to move along a route based on the one or more routes searched out by the route searching unit 23. Examples of the transportation system include a sharing vehicle, a railway, a bus, an air craft, and a ship.

Subsequently, the recommendation unit 24 selects and assigns a transportation system which can be used between recommended transit locations which are located on the route or around the route from the identified transportation systems. When there are a plurality of transportation systems which can be used, it is preferable that a sharing vehicle be preferentially assigned.

A recommended transit location is preferably suitable for the purpose input by the user, but is not limited thereto and, for example, a location popular with other users or the like may be included in the recommended transit locations.

Subsequently, the recommendation unit 24 generates recommendation information using the route searched out by the route searching unit 23, the transportation system which is used for movement along the route, the recommended transit locations, and the like. When the transportation system which is used is a sharing vehicle, a rental place and a return place of the sharing vehicle are included in the recommendation information. Similarly, as for other transportation systems, a place at which use is started and a place at which use is ended such as a boarding place and an alighting place are preferably included in the recommendation information.

When there is a plurality of routes searched out by the route searching unit 23 at the time of generating the recommendation information, it is preferable that a route to which a sharing vehicle is assigned as a transportation system to be used be preferentially used.

Subsequently, the recommendation unit 24 transmits the recommendation information to the information terminal 1, that is, presents the recommendation information to the user.

The reservation receiving unit 25 receives application for a reservation for use from the user by receiving use reservation application information of the sharing vehicle from the information terminal 1. The use reservation application information includes, for example, details for applying for use of the sharing vehicle at the rental place and the return place included in the recommendation information presented to the user.

The reservation settling unit 26 settles the reservation for use of the sharing vehicle based on the use reservation application information received from the information terminal 1 and registers use reservation information of the sharing vehicle in a database.

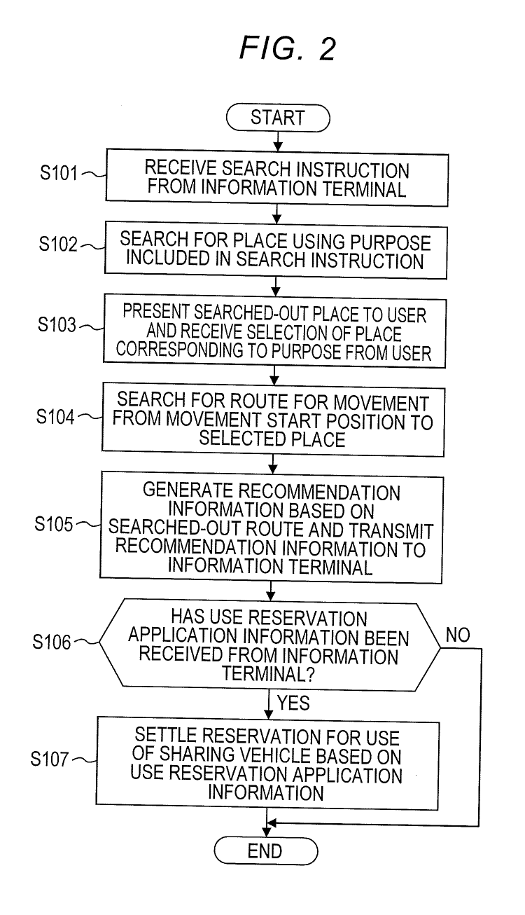

An example of an operation of the server 2 according to the embodiment will be described below with reference to FIG. 2.

First, the communication unit 28 of the server 2 receives a search instruction which is transmitted from the communication unit 15 of the information terminal 1 (Step S101).

Subsequently, the target place searching unit 21 of the server 2 searches for one or more places using a purpose included in the search instruction received in Step S101 (Step S102).

Subsequently, the place selection receiving unit 22 of the server 2 presents the places searched out in Step S102 to the user and receives selection of one or more places suitable for the user's purpose from the user (Step S103) When only one place is searched out in Step S102, Step S103 is skipped.

Subsequently, the route searching unit 23 of the server 2 searches for one or more routes for movement from the movement start position to the place selected in Step S103 based on the search instruction received in Step S101 (Step S104). When Step S103 is skipped, the route is searched out using the place searched out in Step S102 instead of the place selected in Step S103.

Subsequently, the recommendation unit 24 of the server 2 generates recommendation information based on one or more routes searched out in Step S104 and transmits the recommendation information to the information terminal 1 (Step S105).

Subsequently, when the reservation receiving unit 25 of the server 2 has received use reservation application information for a sharing vehicle from the information terminal 1 (YES in Step S106), the reservation settling unit 26 of the server 2 settles the reservation for use of the sharing vehicle based on the use reservation application information (Step S107). Then, this operation ends.

On the other hand, when the reservation receiving unit 25 of the server 2 has not received use reservation application information for a sharing vehicle from the information terminal 1 (NO in Step S106), this operation ends.

As described above, in the recommendation system 100 according to the embodiment, the server 2 can receive a search instruction including a purpose and a movement start position which are input by a user, search for a route for movement from the movement start position to a place corresponding to the purpose based on the search instruction, generate recommendation information including a rental place and a return place of a sharing vehicle based on the route, and present the recommendation information to the user. The server 2 can receive application for a reservation for use of the sharing vehicle for the rental place and the return place included in the recommendation information presented to the user from the user and settle the reservation for use of the sharing vehicle.

That is, in the recommendation system 100 according to the embodiment, a route suitable for a purpose desired by a user can be searched for, recommendation information including a rental place and a return place of a sharing vehicle can be generated based on the searched-out route and be presented to the user, application for a reservation for use of the sharing vehicle can be received from the user based on the recommendation information, and the reservation for use of the sharing vehicle can be settled.

Therefore, with the recommendation system 100 according to the embodiment, it is possible to promote use of a sharing vehicle and thus to promote use of a car sharing service.

### Modified Example

The disclosure is not limited to the above-mentioned embodiment and can be modified into various forms without departing from the gist of the disclosure. Accordingly, the above-mentioned embodiment is exemplary in all respects and is not to be construed as restrictive. For example, the above-mentioned steps of the routine may be performed in an arbitrarily changed order or in parallel as long as the process details do not cause inconsistency.

Elements of the information terminal 1 and the server 2 are not limited to the elements in the above-mentioned embodiment and an arbitrary element can be appropriately added thereto if necessary.

In the above-mentioned embodiment, the server 2 is constituted as a single device, but the functional elements of the server (the target place searching unit 21, the place selection receiving unit 22, the route searching unit 23, the recommendation unit 24, the reservation receiving unit 25, the reservation settling unit 26, the storage unit 27, and the communication unit 28) may be distributed into a plurality of devices. For example, the reservation receiving unit 25 and the reservation settling unit 26 may be excluded from the configuration of the server 2 and may be provided in a device other than the server 2. In this case, the storage unit 27 and the communication unit 28 may be provided in both devices.

What is claimed is:

1. A recommendation device comprising:
a search instruction receiving unit configured to receive a search instruction including a purpose and a movement start position, the purpose and the movement start position being input by a user;
a route searching unit configured to, based on the search instruction, search for a route for movement from the movement start position to a place corresponding to the purpose; and
a recommendation unit configured to
generate, based on the route, recommendation information including at least a rental place of a vehicle, the vehicle being used for a service of car sharing, and a return place of the vehicle, and
present the recommendation information to the user.

2. The recommendation device according to claim 1, further comprising:
a reservation receiving unit configured to, from the user, receive application for a reservation for use of the vehicle at the rental place and the return place; and
a reservation settling unit configured to settle the reservation for use of the vehicle, the vehicle being a target of the application.

3. The recommendation device according to claim 1, further comprising:
a place selecting unit configured to search for a place using the purpose; and
a selection receiving unit configured to
present, to the user, a plurality of places searched out by the place searching unit, and
receive, from the user, selection of a target place corresponding to the purpose,
wherein the route searching unit is configured to search for a route for movement from the movement start position to the target place.

4. The recommendation device according to claim 1, wherein the recommendation information includes, as a transportation system used for movement, at least one of a railway, a bus, an aircraft, and a ship in addition to the vehicle.

5. An information terminal comprising:
a transmission unit configured to transmit a search instruction including a purpose and a movement start position in response to an operation instruction from a user; and
a display unit configured to receive and display recommendation information including a route for movement from the movement start position to a place corresponding to the purpose, the recommendation information including at least a rental place of a vehicle used for a service of car sharing and a return place of the vehicle.

6. A recommendation method performed by a processor, the recommendation method comprising:
receiving a search instruction including a purpose and a movement start position, the purpose and the movement start position being input by a user;
searching, based on the search instruction, for a route for movement from the movement start position to a place corresponding to the purpose;
generating, based on the route, recommendation information including at least a rental place of a vehicle used for a service of car sharing and a return place of the vehicle; and
presenting the recommendation information to the user.

7. A recommendation method performed by a processor, the recommendation method comprising:
transmitting a search instruction including a purpose and a movement start position in response to an operation instruction from a user; and
receiving and displaying recommendation information including a route for movement from the movement start position to a place corresponding to the purpose, the recommendation information including at least a rental place of a vehicle used for a service of car sharing and a return place of the vehicle.

8. A non-transitory storage medium storing a recommendation program, the recommendation program causing a computer to perform:
receiving a search instruction including a purpose and a movement start position, the purpose and the movement start position being input by a user;
searching, based on the search instruction, for a route for movement from the movement start position to a place corresponding to the purpose; generating, based on the route, recommendation information; and
presenting the recommendation information to the user, the recommendation information including at least a rental place of a vehicle used for a service of car sharing and a return place of the vehicle.

9. A non-transitory storage medium storing a recommendation program, the recommendation program causing a computer to perform:
transmitting a search instruction including a purpose and a movement start position in response to an operation instruction from a user; and
receiving and displaying recommendation information including a route for movement from the movement start position to a place corresponding to the purpose, the recommendation information including at least a rental place of a vehicle which is used for a service of car sharing and a return place of the vehicle.
